(19) United States
(12) Patent Application Publication
(10) Pub. No.: US 2013/0275051 A1
(43) Pub. Date: Oct. 17, 2013

(54) COMPUTING DEVICE AND METHOD FOR DETECTING CELL DEATH IN A BIOLOGICAL SAMPLE

(71) Applicants: Golnaz Farhat, Toronto (CA); Adrian Linus Dinesh Mariampillai, Toronto (CA); Victor X.D. Yang, Toronto (CA); Gregory Jan Czarnota, Oakville (CA); Michael Kolios, Ancaster (CA)

(72) Inventors: Golnaz Farhat, Toronto (CA); Adrian Linus Dinesh Mariampillai, Toronto (CA); Victor X.D. Yang, Toronto (CA); Gregory Jan Czarnota, Oakville (CA); Michael Kolios, Ancaster (CA)

(21) Appl. No.: 13/880,986

(22) PCT Filed: Apr. 4, 2012
(86) PCT No.: PCT/CA2012/000335

§ 371 Date: Jul. 2, 2013

Related U.S. Application Data
(60) Provisional application No. 61/472,718, filed on Apr. 7, 2011.

(51) Int. Cl. G06F 19/10

(52) U.S. Cl. CPC G06F 19/10
USPC 702/19

(57) ABSTRACT

A computing device system and method for detecting cell death in a biological sample is provided. A plurality of optical coherence tomography (OCT) data sets are received, each representative of OCT backscatter data collected from the biological sample and comprising respective signal fluctuation as a function of time at different respective times over a given time period. Respective indications of respective signal decorrelation rates are determined for each of the plurality of OCT data sets at each of the different respective time. It is determined that cell death has occurred in the biological sample when the respective indications of respective signal decorrelation rates changes over the given time period

### FIELD

The specification relates generally to medical devices, and specifically to a computing device and method for detecting cell death in a biological sample.

### BACKGROUND

Determination of cell death in biological samples can be performed by comparing optical coherence tomography data of cells in the biological samples with a known untreated sample. However, such a comparison is dependent on acquiring baseline data from an untreated sample.

### SUMMARY

An aspect of the specification provides a computing device for detecting cell death in a biological sample, the computing device comprising: a processor, a memory and a communication interface, the processor enabled to: receive a plurality of optical coherence tomography (OCT) data sets, each representative of OCT backscatter data collected from the biological sample and comprising respective intensity fluctuation as a function of time at different respective times over a given time period; determine respective indications of respective signal decorrelation rates for each of the plurality of OCT data sets at each of the different respective times; and determine that cell death has occurred in the biological sample when the respective indications of respective signal decorrelation rates changes over the given time period.

The processor can be further enabled to normalize each of the plurality of OCT data sets prior to the respective indications of respective signal decorrelation rates being determined. To normalize each of the plurality of OCT data sets, the processor can be further enabled to subtract a respective signal mean from a respective original signal and divide by a respective standard deviation for each of the plurality of OCT data sets.

The processor can be further enabled to determine the respective indications of respective signal decorrelation rates by at least one of an autocorrelation analysis, power spectral density analysis, and wavelet analysis.

The processor can be further enabled to determine the respective indications of respective signal decorrelation rates by applying an auto-correlation function to the respective intensity fluctuation at each different respective time.

The respective indications of respective signal decorrelation rates can comprise at least one of: a respective decay rate; a respective decorrelation time; a respective wavelet power spectrum amplitude; a respective decay metric; a respective half-width-half-max of respective auto-correlation curves; and a respective exponential decay metric of the respective auto-correlation curves.

The processor can be further enabled to apply the function at a common region of interest (ROI) in each of the plurality of OCT data sets.

The biological sample can comprise an in-vitro biological sample.

The biological sample can comprise an in-vivo biological sample, and wherein the processor can be further enabled to apply at least one in-vivo correction to each of the plurality of OCT data sets prior to the respective indications of respective signal decorrelation rates being determined to remove effects of in-vivo phenomenon from each of the plurality of OCT data sets.

The plurality of OCT data sets can be received via the communication interface.

The plurality of OCT can be stored in the memory.

The processor can be further enabled to, at least one of: store a cell death result in the memory when the processor determines whether the cell death has occurred; output the cell death result to an output device; and transmit the cell death result to a remote computing device via the communication interface.

The computing device can further comprise OCT apparatus for obtaining the plurality of OCT data sets.

Another aspect of the specification provides a method for detecting cell death in a biological sample using a computing device comprising a processor, the method comprising: receiving a plurality of optical coherence tomography (OCT) data sets, each representative of OCT backscatter data collected from the biological sample and comprising respective intensity fluctuation as a function of time at different respective times over a given time period; determining respective indications of respective signal decorrelation rates for each of the plurality of OCT data sets at each of the different respective times; and, determining that cell death has occurred in the biological sample when the respective indications of respective signal decorrelation rates changes over the given time period.

The method can further comprise normalizing, at the processor, each of the plurality of OCT data sets prior to the determining the respective indications of respective signal decorrelation rates. Normalizing can comprise subtracting a respective signal mean from a respective original signal and dividing by a respective standard deviation for each of the plurality of OCT data sets.

Determining the respective indications of respective signal decorrelation rates can occur by at least one of an autocorrelation analysis, power spectral density analysis, and wavelet analysis.

Determining the respective indications of respective signal decorrelation rates can occur by applying an auto-correlation function to the respective intensity fluctuation at each different respective time.

Respective indications of respective decay rates can comprise one of: a respective decay rate; a respective decorrelation time; a respective wavelet power spectrum amplitude; a respective decay metric; a respective half-width-half-max of respective auto-correlation curves; and a respective exponential decay metric of the respective auto-correlation curves.

The function can be applied to a common region of interest (ROI) in each of the plurality of OCT data set.

The biological sample can comprise an in-vitro biological sample.

The biological sample can comprise an in-vivo biological sample, and the method can further comprise applying at least one in-vivo correction to each of the plurality of OCT data sets prior to the determining the respective indications of respective signal decorrelation rates to remove effects of in-vivo phenomenon from each of the plurality of OCT data sets.

Yet a further aspect of the specification comprises a computer program product, comprising a computer usable medium having a computer readable program code adapted to be executed to implement a method for detecting cell death in a biological sample using a computing device comprising a processor, the method comprising: receiving a plurality of optical coherence tomography (OCT) data sets, each representative of OCT backscatter data collected from the biological sample and comprising respective intensity fluctuation as a function of time at different respective times over a given time period; determining respective indications of respective signal decorrelation rates for each of the plurality of OCT data sets at each of the different respective times; and, determining that cell death has occurred in the biological sample when the respective indications of respective signal decorrelation rates changes over the given time period.

A further aspect of the specification provides a computing device for detecting cell death in a biological sample, the computing device comprising: a processor, a memory and a communication interface, the processor enabled to: receive a plurality of optical coherence tomography (OCT) data sets, each representative of OCT backscatter data collected from the biological sample and comprising respective signal fluctuation as a function of time at different respective times over a given time period; determine respective indications of respective signal decorrelation rates for each of the plurality of OCT data sets at each of the different respective times; and, determine that cell death has occurred in the biological sample when the respective indications of respective signal decorrelation rates changes over the given time period.

The processor can be further enabled to normalize each of the plurality of OCT data sets prior to the respective indications of respective signal decorrelation rates being determined. To normalize each of the plurality of OCT data sets, the processor can be further enabled to subtract a respective signal mean from a respective original signal and divide by a respective standard deviation for each of the plurality of OCT data sets.

The processor can be further enabled to determine the respective indications of respective signal decorrelation rates by at least one of an autocorrelation analysis, power spectral density analysis, and wavelet analysis.

The processor can be further enabled to determine the respective indications of respective signal decorrelation rates by applying an auto-correlation function to the respective signal fluctuation at each different respective time.

The respective indications of respective signal decorrelation rates can comprise at least one of: a respective decay rate; a respective decorrelation time; a respective wavelet power spectrum amplitude; a respective decay metric; a respective half-width-half-max of respective auto-correlation curves; and, a respective exponential decay metric of the respective auto-correlation curves.

The processor can be further enabled to apply the function at a common region of interest (ROI) in each of the plurality of OCT data sets.

The biological sample can comprise an in-vitro biological sample.

The biological sample can comprise an in-vivo biological sample, and the processor can be further enabled to apply at least one in-vivo correction to each of the plurality of OCT data sets prior to the respective indications of respective signal decorrelation rates being determined to remove effects of in-vivo phenomenon from each of the plurality of OCT data sets.

The plurality of OCT data sets can be received via the communication interface.

The plurality of OCT can be stored in the memory.

The processor can be further enabled to at least one of: store a cell death result in the memory when the processor determines whether the cell death has occurred; output the cell death result to an output device; and transmit the cell death result to a remote computing device via the communication interface.

The computing device can further comprise OCT apparatus for obtaining the plurality of OCT data sets.

Yet a further aspect of the specification provides a method for detecting cell death in a biological sample using a computing device comprising a processor, the method comprising: receiving a plurality of optical coherence tomography (OCT) data sets, each representative of OCT backscatter data collected from the biological sample and comprising respective signal fluctuation as a function of time at different respective times over a given time period; determining respective indications of respective signal decorrelation rates for each of the plurality of OCT data sets at each of the different respective times; and determining that cell death has occurred in the biological sample when the respective indications of respective signal decorrelation rates changes over the given time period.

The method can further comprise normalizing, at the processor, each of the plurality of OCT data sets prior to the determining the respective indications of respective signal decorrelation rates. Normalizing can comprise subtracting a respective signal mean from a respective original signal and dividing by a respective standard deviation for each of the plurality of OCT data sets.

Determining the respective indications of respective signal decorrelation rates can occur by at least one of an autocorrelation analysis, power spectral density analysis, and wavelet analysis.

Determining the respective indications of respective signal decorrelation rates can occur by applying an auto-correlation function to the respective signal fluctuation at each different respective time.

The respective indications of respective decay rates can comprise one of: a respective decay rate; a respective decorrelation time; a respective wavelet power spectrum amplitude; a respective decay metric; a respective half-width-half-max of respective auto-correlation curves; and a respective exponential decay metric of the respective auto-correlation curves.

The function can be applied to a common region of interest (ROI) in each of the plurality of OCT data set.

The biological sample can comprise an in-vitro biological sample.

The biological sample can comprise an in-vivo biological sample, and the method can further comprise applying at least one in-vivo correction to each of the plurality of OCT data sets prior to the determining the respective indications of respective signal decorrelation rates to remove effects of in-vivo phenomenon from each of the plurality of OCT data sets.

Another aspect of the specification provides a computer program product, comprising a computer usable medium having a computer readable program code adapted to be executed to implement a method for detecting cell death in a biological sample using a computing device comprising a processor, the method comprising: receiving a plurality of optical coherence tomography (OCT) data sets, each representative of OCT backscatter data collected from the biological sample and comprising respective signal fluctuation as a function of time at different respective times over a given time period; determining respective indications of respective signal decorrelation rates for each of the plurality of OCT data sets at each of the different respective times; and determining that cell death has occurred in the biological sample when the respective indications of respective signal decorrelation rates changes over the given time period.

### BRIEF DESCRIPTIONS OF THE DRAWINGS

For a better understanding of the various implementations described herein and to show more clearly how they may be carried into effect, reference will now be made, by way of example only, to the accompanying drawings in which:

FIG. 1 depicts a system for detecting cell death in a biological sample, according to non-limiting implementations.

FIG. 2 depicts a method for detecting cell death in a biological sample, according to non-limiting implementations.

FIG. 3 depicts a system for detecting cell death in a biological sample, according to non-limiting implementations.

FIG. 4 depicts an OCT b-mode image of an acute myeloid leukemia (AML) cell pellet (scale bar=100 μm) with an analysis region of interest (ROI) outlined by a dotted line, according to non-limiting implementations.

FIG. 5 depicts the ROI of FIG. 4 enlarged and a single pixel outlined in a circle to illustrate a data analysis technique, according to non-limiting implementations.

FIG. 6 depicts a signal intensity as a function of time for a single pixel of the ROI of FIG. 5, according to non-limiting implementations.

FIG. 7 depicts hematoxylin and eosin (H&E) stained sections obtained from cisplatin treated AML cells after 0 hours (A), 12 hours (B), 24 hours (C) and 48 hours (D) of treatment (the scale bar represents 10 μm); representative signal intensity fluctuations from a single pixel are depicted at 0 hours (E), 12 hours (F), 24 hours (G) and 48 hours (H), according to non-limiting implementations.

FIG. 8 depicts average autocorrelation functions computed from a selected ROI in AML cell pellets, according to non-limiting implementations.

FIG. 9 depicts decorrelation time computed from AML cell samples treated with cisplatin over a 48 hour period, according to non-limiting implementations. Each curve corresponds to a separate experiment and each point corresponds to an individual cell pellet. Error bars represent the standard deviation of 10 separate measurements from each sample.

FIG. 10 depicts a system for detecting cell death in a biological sample, according to non-limiting implementations.

FIG. 11 depicts decorrelation time computed from human bladder carcinoma (HT-1376) tumors grown within a dorsal skin-fold window chamber model in a plurality of mice, according to non-limiting implementations. Tumor were treated with a single dose of cisplatin at 0 hours and imaged using OCT at 0 hours, 24 hours and 48 hours.

### DETAILED DESCRIPTION

In optical coherence tomography (OCT) images, speckle intensities depend on the number, size, optical properties and spatial distribution of scatterers within a resolution volume (RV). Imaging of living cells and tissues produces changes in the speckle pattern due to the motion of subresolution optical scatterers. In addition to the presence of red blood cells flowing within the vasculature, scatterer motion in tissue can be caused by intracellular motion. Examples include the movement of organelles along microtubules, the process of mitosis, and the morphological changes associated with cell death, which can include but is not limited to apoptosis.

Using apoptosis as a non-limiting example of cell death, during apoptosis a predictable sequence of biochemical and morphological changes leads to cell death. This mode of cell death is essential in human development and homeostasis and many cancer therapies take advantage of apoptosis in proliferating cancer cells to reduce tumor burden and cure patients. Morphologically, apoptosis is characterized by a rounding and shrinking of the cell, fragmentation of the nucleus and other organelles, membrane blebbing and, ultimately, disintegration of the cell into intact membrane-bound fragments called apoptotic bodies.

It is appreciated that the rate of intracellular motion in apoptotic cells will be higher than in viable cells due to the remodeling of the cytoskeleton during membrane blebbing and cell fragmentation. Such an increase in intracellular motion is detected using implementations described herein using principles of dynamic light scattering (DLS) adapted to OCT.

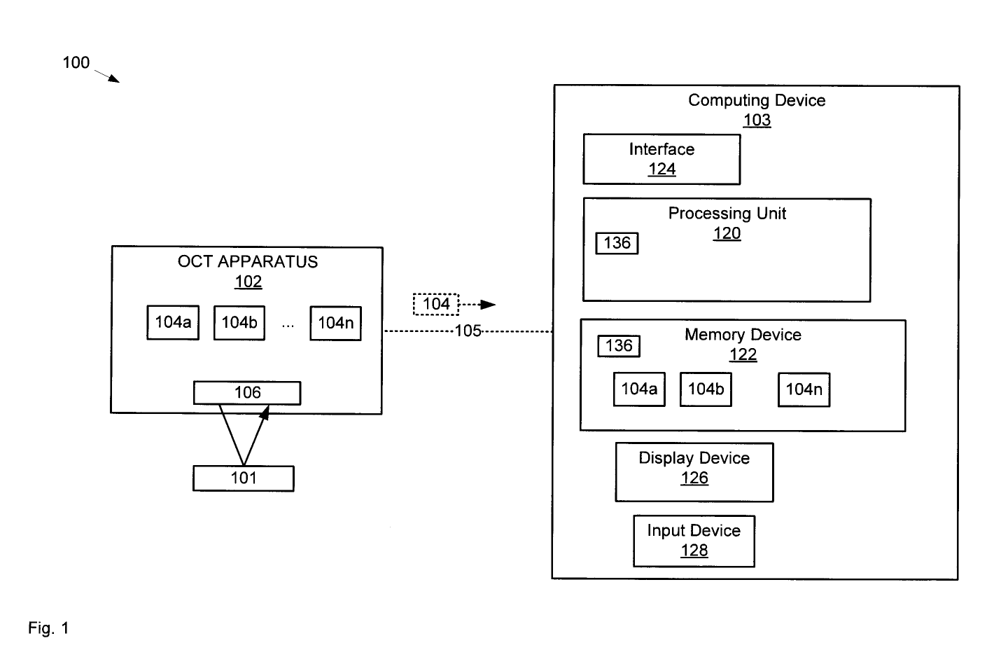

For example, attention is directed to FIG. 1 which depicts a system 100 for detecting cell death in a biological sample 101, according to non-limiting implementations. System 100 comprises an OCT apparatus 102 and a computing device 103. OCT apparatus 102 is enabled to collect a plurality of optical coherence tomography (OCT) data sets 104a, 104b . . . 104n (collectively OCT data sets 104 and generically an OCT data set) from sample 101. Each OCT data set 104 is representative of OCT backscatter data collected from biological sample 101 at different respective times over a given time period. For example, the given time period can be any time period over which cell death is expected to occur, however any suitable time period is within the scope of present implementations. Each OCT data set 104 is collected at a different respective time over the given time period according to any suitable scheme, for example periodically, or at any suitable interval or plurality of intervals. It is appreciated, however, that an initial OCT data set 104 is collected at the beginning of the given time period to establish a baseline for sample 101.

Furthermore, computing device 103, referred to hereafter as device 103, can receive OCT data sets 104 from OCT apparatus 102 in any suitable manner, including but not limited to a link 105, a communication network, transferable memory media (e.g. diskettes, flash memory or the like). It is further appreciated that OCT data sets 104 can be received as they are collected at OCT apparatus and/or in batches and/or all at once.

OCT apparatus 102 can comprise any suitable OCT apparatus. In particular non-limiting implementations OCT apparatus comprises using a swept-source OCT system with a 1300 nm light source such as a swept source OCT (OCM1300SS) system from Thorlabs™ Inc. (Newton, N.J.). In general, OCT apparatus 102 includes a scanner 106 for scanning sample 101, scanner 106 enabled to acquire light backscatter data from sample 101. It is appreciated, however, that any suitable OCT apparatus using any suitable light source with any suitable wavelength is within the scope of present implementations, including but not limited to non-swept light source OCT imagers.

Device 103 comprises a processing unit 120 interconnected with a memory device 122, a communication interface 124, and alternatively a display device 126 and an input device 128, for example via a computing bus (not depicted). Memory device 122, communication interface 124, and display device 126 will also be referred to hereafter as, respectively, memory 122, interface 124 and display 126. Device 103 further comprises an application 136 for detecting cell death in a biological sample from OCT data sets 104, as will be explained below. Application 136 can be stored in memory 122 and processed by processing unit 120.

It is further appreciated that link 105, when present, can include any suitable combination of wired and/or wireless links including but not limited to any suitable combination of wired and/or wireless communication networks, packet based networks, the Internet, analog networks and the like, and/or a combination.

In general, device 103 comprises any suitable computing device for processing application 136, including but not limited to any suitable combination of servers, personal computing devices, portable computing devices, laptop computing devices, and the like. Other suitable computing devices are within the scope of present implementations.

Processing unit 120 comprises any suitable processor, or combination of processors, including but not limited to a microprocessor, a central processing unit (CPU) and the like. Other suitable processing units are within the scope of present implementations.

Memory 122 can comprise any suitable memory device, including but not limited to any suitable one of, or combination of, volatile memory, non-volatile memory, random access memory (RAM), read-only memory (ROM), hard drive, optical drive, flash memory, magnetic computer storage devices (e.g. hard disks, floppy disks, and magnetic tape), optical discs, and the like. Other suitable memory devices are within the scope of present implementations. In particular, memory 122 is enabled to store application 136 and in some implementations for data storage, such as storage of OCT data sets 104.

Communication interface 124 comprises any suitable communication interface, or combination of communication interfaces. Interface 124 can be enabled to communicate with OCT apparatus 102 via link 105. Accordingly, interface 124 can enabled to communicate according to any suitable protocol which is compatible with link 105, including but not limited to any suitable combination of wired and/or wireless communication protocols, the Internet protocols, analog protocols and the like, and/or a combination. However, communication interface 124 is appreciated not to be particularly limiting.

Input device 128 is generally enabled to receive input data, and can comprise any suitable combination of input devices, including but not limited to a keyboard, a keypad, a pointing device, a mouse, a track wheel, a trackball, a touchpad, a touch screen and the like. Other suitable input devices are within the scope of present implementations.

Display 126 comprises any suitable one of or combination of CRT (cathode ray tube) and/or flat panel displays (e.g. LCD (liquid crystal display), plasma, OLED (organic light emitting diode), capacitive or resistive touchscreens, and the like).

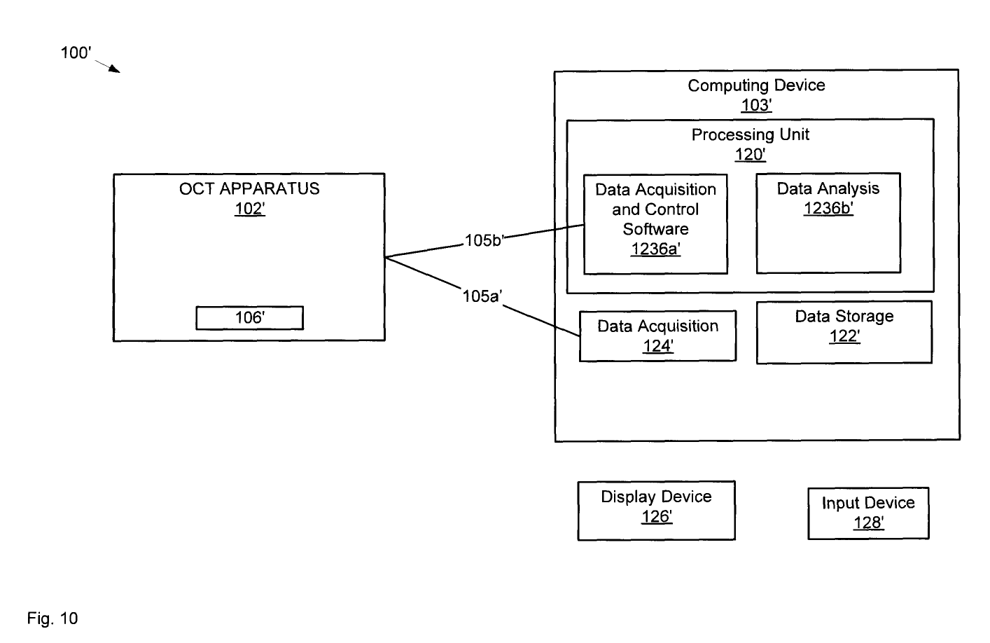

Attention is now directed to FIG. 10, which depicts an alternative system 100′ for detecting cell death in a biological sample, according to non-limiting implementations. It is appreciated that system 100′ is similar to system 100, with like elements having like numbers, with a prime (′) symbol appended thereto. Indeed, it is appreciated that system 100′ is substantially the same as system 100, however various hardware and software components are depicted to provide further clarity. In general system 100′ comprises apparatus 102′ and device 103′. Apparatus 102′ comprises scanner 106′. Device 103′ comprises a processing unit 120′, data storage 122′, and a module for data acquisition 124′. Further, data storage 122′ is similar to memory 122, and is enabled for storage of data such as data sets 104. The module for data acquisition 124′ is similar to interface 124, and is in communication with OCT apparatus 102′ via a link 105a′. Data acquisition and control software 1236a′ at device 103′ comprises a module for controlling data acquisition at OCT apparatus 102′ and is in communication with OCT apparatus 102′ via a link 105b′. Links 105a′, 105b′ can be different links or similar links (e.g. different cables or the same cable). In any event, it is appreciated that control signals can be transmitted to OCT apparatus 102′ to control acquisition of OCT data via scanner 106′, such as data sets 104, the OCT data received from OCT apparatus 102′ via the module for data acquisition 124′ and stored in data storage 122′. Device 103′ further comprises a further software module for data analysis 1236b′ comprising software for analysing the OCT data. In some implementations application 136 described above comprises modules 1236a, 1236b′. Display device 126′ and input device 128′ are depicted as external to device 103′ but are appreciated to be in communication with device 103′; in other implementations device 103′ can comprise display device 126′ and input device 128′

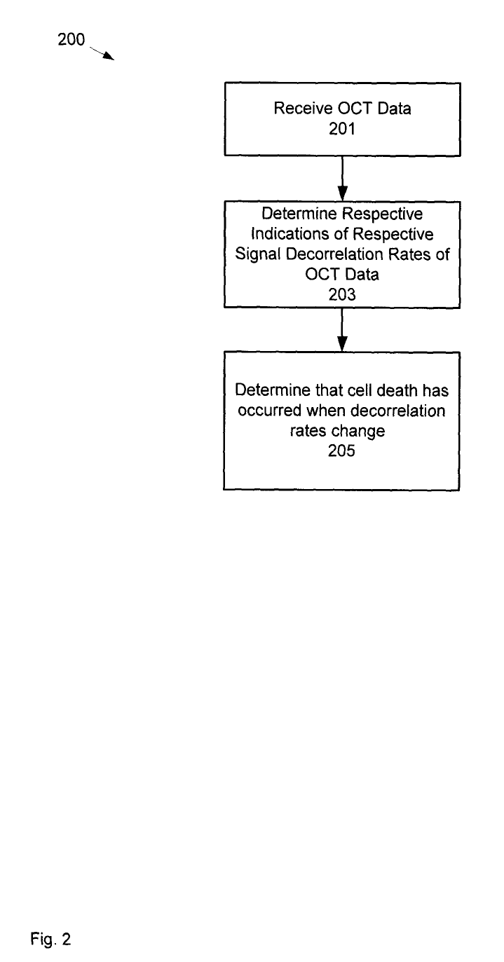

Attention is now directed to FIG. 2 which depicts a method 200 for detecting cell death in a biological sample. In order to assist in the explanation of method 200, it will be assumed that method 200 is performed using system 100. Furthermore, the following discussion of method 200 will lead to a further understanding of system 100 and its various components. However, it is to be understood that system 100 and/or method 200 can be varied, and need not work exactly as discussed herein in conjunction with each other, and that such variations are within the scope of present embodiments.

It is appreciated that method 200 is implemented in system 100 by processing unit 120. However, method 200 could also be implemented in system 100′ by processing unit 120′.

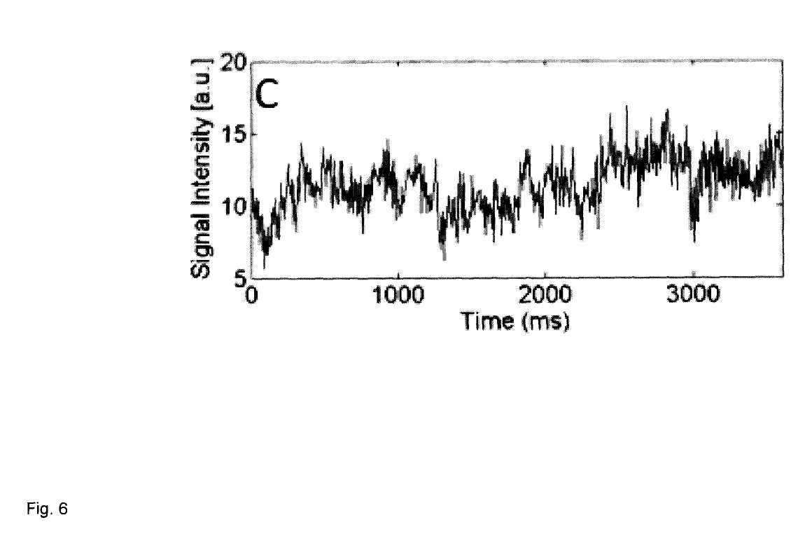

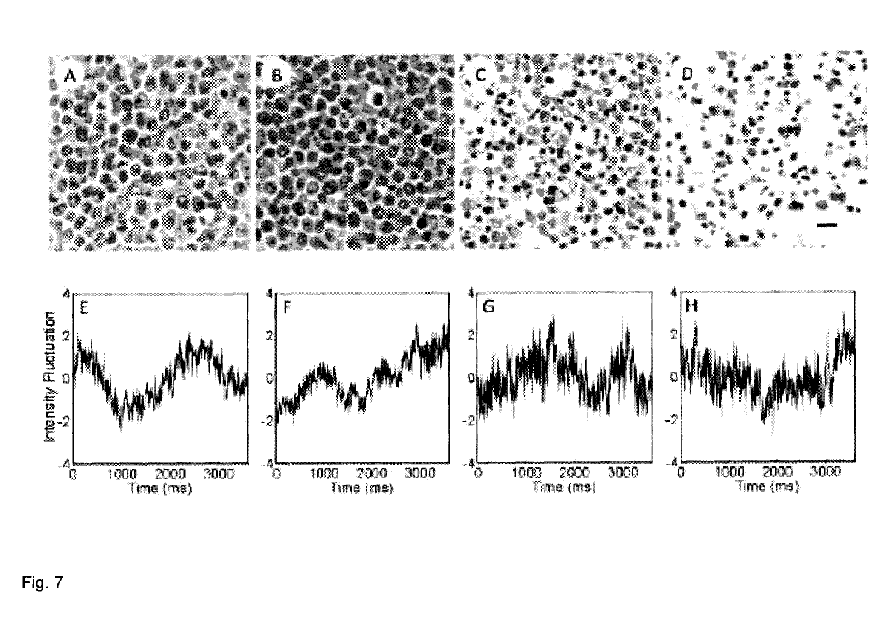

At 201, OCT data sets 104 are received in any suitable manner as described above. It is appreciated that OCT data sets 104 are each representative of OCT backscatter data collected from biological sample 101, via scanner 106, at different respective times over a given time period as described above and comprise respective intensity fluctuation as a function of time at different respective times over the given time period. It is appreciated, however, that OCT data sets 104 can comprises any suitable signal fluctuation as a function of time, including, but not limited to intensity fluctuations, amplitude fluctuations, phase fluctuations and fringe fluctuations. Indeed, a person of skill in the art would appreciate that the example of intensity fluctuations discussed herein is merely representative of signal fluctuations of any suitable type. In any event, in some implementations, each OCT data set 104 can then be normalized. Furthermore, FIGS. 6 and 7, described below, depict non-limiting graphical depictions of un-normalized and normalized OCT data sets 104, respectively. It is appreciated that at least a baseline OCT data set and at least one further OCT data set are acquired, for example in a time period over which cell death is expected to occur, including but not limited to about 24 hours to about 48 hours.

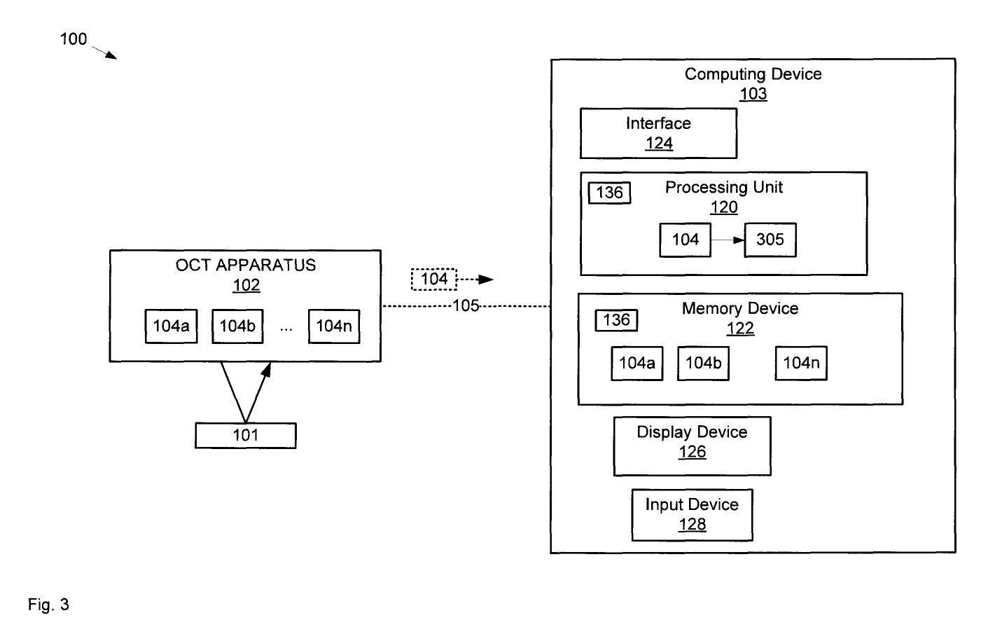

At 203, and with further reference to FIG. 3 (substantially similar to FIG. 1 with like elements having like numbers), respective indications 305 of respective signal decorrelation rates for each of the plurality of OCT data sets 104 are determined at each of the different respective times by processing unit 120 processing data sets 104 to produce indications 305. Determination of respective indications 305 of signal decorrelation rates can occur using any suitable technique, including but not limited to autocorrelation analysis, power spectral density analysis, wavelet analysis or the like. The respective indication 305 of respective signal decorrelation rates can include but is not limited to: a respective decay rate; a respective decorrelation time; a respective wavelet power spectrum amplitude; a respective decay metric of the respective fluctuation curves; a respective half-width-half-max of the respective auto-correlation respective fluctuation curves; a respective exponential decay metric of the respective auto-correlation curves; or the like.

Returning to FIG. 2, at 205, it is determine that cell death has occurred in sample 101 when the respective indications 305 of respective signal decorrelation rates changes over the given time period, as will be explained in further detail below.

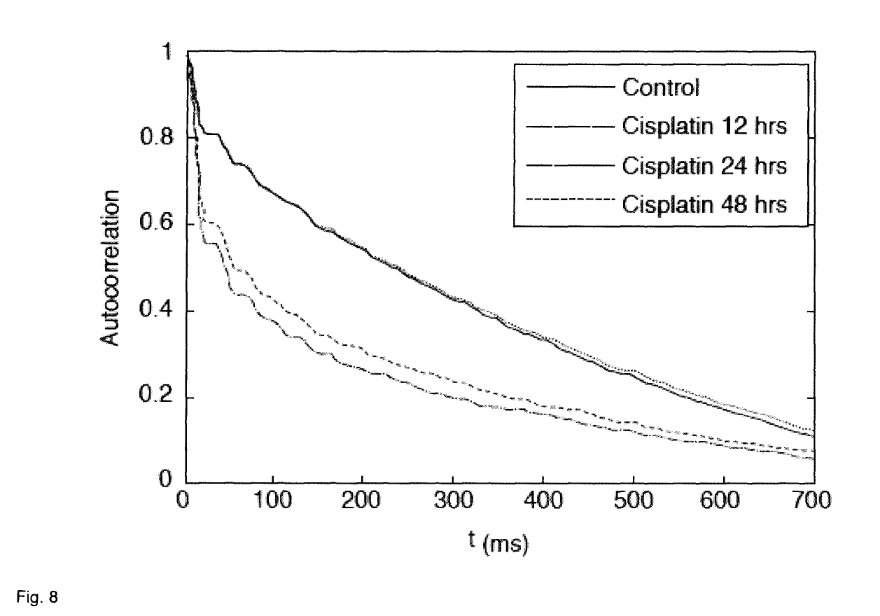

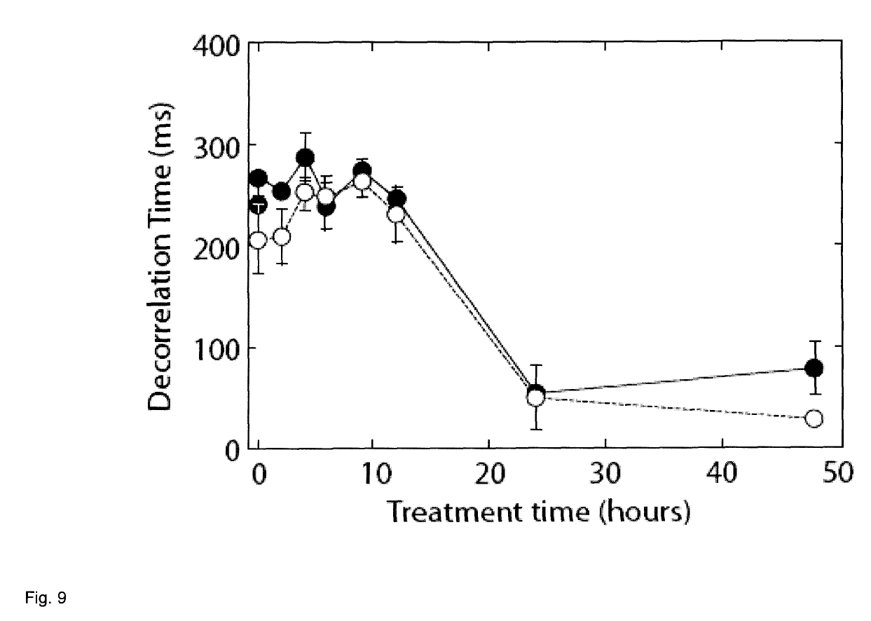

In specific non-limiting examples autocorrelation analysis of normalized signal intensity fluctuation of each OCT data set 104 occurs (e.g. the curves of FIG. 7) and the decorrelation time (e.g. indication 305) is extracted as represented by the half width at half max of respective autocorrelation curves (e.g. the curves of FIG. 8). The decorrelation times are then plotted out as a function of time, as in FIG. 9. As the decorrelation time decreases in FIG. 9, it is determined that cell death has been detected. It is further appreciated that decorrelation time is inversely related to the decorrelation rate; hence, had decorrelation rate been plotted as function of time, the decorrelation rate would have been observed to increase, which is also indicative that cell death has been detected.

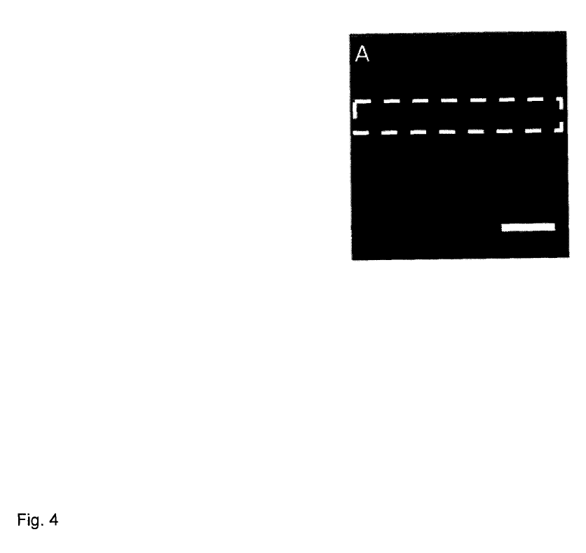

A non-limiting successful experiment demonstrating method 200 is now described in detail with further reference to FIGS. 4 through 9.

Apoptosis was induced in acute myeloid leukemia (AML) cells using the chemotherapeutic agent cisplatin and cell pellets (i.e. sample 101, which in the non-limiting experiment comprises various in-vitro biological samples) were imaged using OCT apparatus 102 after 0, 2, 4, 6, 9, 12, 24 and 48 hours of treatment.

Optical coherence tomography data (i.e. OCT data sets 104) was acquired in the form of 14-bit interference fringe signals using a Thorlabs™ Inc. (Newton, N.J.) swept source OCT (OCM1300SS) system (i.e. OCT apparatus 102). Two-dimensional frames containing 32 axial scans were recorded covering a transverse distance of 400 μm at a frame rate of 166 Hz.

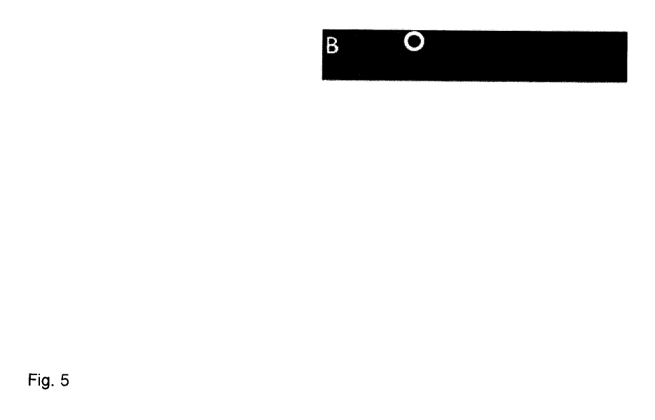

A region of interest (ROI) measuring 32 pixels in the transverse direction and 8 pixels in the axial direction was selected starting at 30 μm below the sample surface. For each pixel location, the signal intensity was plotted across all acquired frames. FIG. 4 depicts raw data acquired from OCT apparatus 102: an OCT b-mode image of an AML cell pellet (scale bar=100 μm) with analysis ROI outlined by dotted line. FIG. 5 depicts an enlargement of the ROI of FIG. 4 and a single pixel outlined in a circle to illustrate the data analysis technique. FIG. 6 depicts signal intensity as a function of time for the single pixel of FIG. 5. It is appreciated from FIG. 6 that over a time scale of about 3 seconds, the signal intensity fluctuates, which is a reflection of movement in sample 101.

Attention is next directed to FIG. 7, which depicts H&E (hematoxylin and eosin stain) stained histological sections in the top row, the histological sections obtained from the cisplatin treated cells after 0 hours (image A), 12 hours (image B), 24 hours (image C) and 48 hours (image D) of treatment. The scale bar represents 10 μm. Representative signal intensity fluctuations from a single pixel for each sample are provided underneath each respective sample, in the bottom row, at 0 hours (plot E), 12 hours (plot F), 24 hours (plot G) and 48 hours (plot H). It is appreciated from the histological sections obtained from fixed AML cell samples as depicted in FIG. 7, images A to D, that, significant structural changes have occurred after 24 hours of cisplatin exposure, and further significant structural changes have occurred after 48 hours. Nuclear condensation and fragmentation were observed as well as irregular cell shapes that can be indicative of cell membrane blebbing.

In any event, the plots of FIG. 7 (i.e. plots E to H) are each similar to the plot of FIG. 6, however the plots of FIG. 7 have been normalized. While any suitable method of normalizing the signal is within the scope of present implementations, in these implementations the signal was normalized by subtracting the signal mean from the original signal and dividing by the standard deviation.

In any event, once OCT data 104 is received at device 103 (in any suitable form as in 201 of method 200, e.g. the raw data, the signal data of FIG. 2, the normalized signal data of FIG. 7 E to H, etc.), and the signal data is determined (normalized or un-normalized as desired), respective indications 305 of respective signal decorrelation rates for each of OCT data set 104 is determined. For example, in present implementations an autocorrelation (AC) function is applied and a decorrelation time is extracted. However, any process for determining a respective decorrelation rate of the signal is within the scope of present implementations.

Since the autocorrelation (AC) function and the power spectrum of a signal are Fourier transform pairs, the autocorrelation of the time intensity signal at each pixel location was calculated by taking the inverse Fourier transform of its power spectrum. Representative plots of the signal intensity fluctuations as a function of time from a single pixel are depicted in FIG. 7, plots E to H. It is appreciated from FIG. 8 that the autocorrelation signal for the cell samples after 12 and 24 hours of cisplatin exposure decays more quickly than a control sample and the cell samples after 48 hours of cisplatin exposure. In other words, the backscatter fluctuations from the samples treated for 24 and 48 hours were higher in amplitude and more erratic than at earlier times. This difference indicates more motion in samples exposed to cisplatin for 24 hours and longer.

Respective indications of respective decay rates for each of respective autocorrelation curves of FIG. 8 were then determined (e.g. block 205 of method 200). While any suitable metric for measuring decay is within the scope of present implementations, an average decorrelation time (DT) was calculated for each data set by measuring the half width of each AC function at half its maximum value. However, in other implementations a different suitable metric can be used, such an exponential decay metric.

FIG. 9 depicts the DT computed from each of the AML cell samples of FIG. 7 treated with cisplatin over a 48 hour period plotted as a function of time. It is appreciated that FIG. 9 depicts two curves and each curve of FIG. 9 corresponds to a respective one of two separate experiments. Error bars represent the standard deviation of 10 separate measurements from each sample. Results from the two separate experiments demonstrated good repeatability of this technique despite the biological variations inherent in such experiments.

The graph in FIG. 9 indicates a significant drop in DT after 24 and 48 hours of cisplatin exposure. The corresponding cell morphology depicted in FIG. 7 suggests that these measurement timepoints correspond to the stage in the apoptotic process where cell membrane blebbing and fragmentation occurs. Hence, it is appreciated that the significant drop in DT over 48 hours is related to an increase in intracellular motion caused by the cytoskeletal and membrane structural changes and reorganization required for this fragmentation.

The resolution volume (RV) of the OCT system in the non-limiting experiment is approximately the size of a single cell. Scatterers giving rise to the signal intensity in each RV can include organelles, such as mitochondria and lysosomes, nuclear material, cytoskeletal components and the cell membrane. Any change in the spatial distribution and scattering strength of these components can introduce fluctuations in the speckle intensity. Events that can modify the scatterer spatial distribution and scattering strength include movement or reorganization of the scatterers within the RV or the arrival and departure of scatterers into and out of this volume. It is appreciated that a cell's contents are continuously moving due to various forces. Motion can be driven by active processes such as organelle transport by motor proteins along microtubules or cytoskeletal restructuring during mitosis and apoptosis. Diffusive transport of small organelles, vesicles and macromolecules is also present due to thermal processes (Brownian motion) as well as from the fluctuation of the cytoplasm caused by movement of motor-bound organelles and the cytoskeleton.

Assuming the dominant optical scatterers inside living cells are the mitochondria and the nucleus, it is appreciated that a change in the rate of motion of cellular components during apoptosis is due to mitochondrial and nuclear fragmentation. In addition to movement related to fragmentation, nuclear and mitochondrial fragments inside a cell will be subject to cytoplasmic motion caused by contractile forces of the cytoskeleton during membrane blebbing and the formation of apoptotic bodies. The period between the induction of apoptosis and the first morphological signs of cell death is asynchronous across a given population of cells and ranges between 2 to 48 hours. The duration of the execution phase (the period during which structural changes occur), however, is largely invariant and can last approximately 2 to 4 hours. Thus, the entire process of cell shrinkage, nuclear fragmentation, membrane blebbing and the formation of apoptotic bodies occurs over a relatively short time in a given apoptotic cell. Hence a significant drop in DT during apoptosis can be indicative of an increase in intracellular motion.

Several simple classical models exist for calculating the dynamic light scattering properties of systems of particles in motion. These include models for the random (Brownian) motion of spherical particles suspended in a liquid medium, the uniform motion of particles subjected to an external force (flow) and the complicated movement of motile micro-organisms. The motion inside living cells is far more complex than any of the existing models, not only because of the various sources of intracellular motion, but also due to the large variation in size of subcellular components. A theoretical treatment of the dynamic light scattering properties of cells can include a combination of the above-mentioned models. It is appreciated that the shape of the AC function depends on the motion of the dominant scatterer in the biological samples, the cell type and the viability of the cell.

In any event, it is appreciated that cell death can be detected by measuring motion in cells over time due to variations in intracellular motion related to cell death. Since this dynamic light scattering technique uses signal fluctuations rather than the absolute value of the signal intensity, the effects of signal attenuation and scattering angle are greatly reduced. Hence present implementations provide advantages over techniques measuring backscatter strength for cell death detection.

While the present sample experiment is directed to in-vitro biological samples, it is appreciated that similar techniques can be applied to in-vivo biological samples, however in-vivo corrections can be applied to each of the plurality of OCT data sets 104 prior to applying the time fluctuation function at 203 of method 200, in order to remove effects of in-vivo phenomenon from each of the plurality of OCT data sets 104. For example, one or more in-vivo corrections can be applied prior to applying the AC function. Hence the effects of bulk motion are removed and areas corresponding to vasculature (blood flow) are segmented and excluded from the analysis ROI.

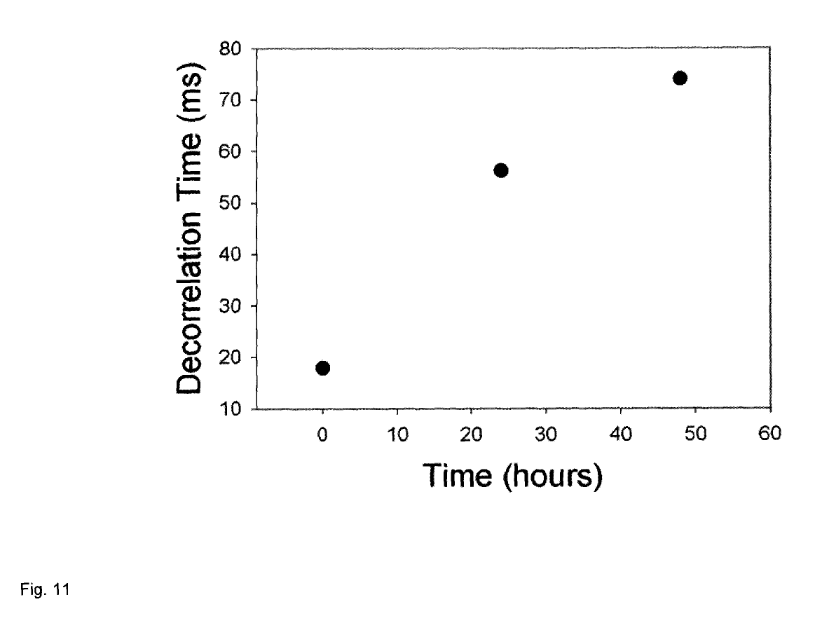

A non-limiting successful experiment demonstrating method 200 with in-vivo samples is next described in detail with reference to FIG. 11.

An in-vivo tumor model used in the successful experiment consisted of human bladder carcinoma (HT-1376) tumors grown within a dorsal skin-fold window chamber model in a plurality of mice. Tumors were treated with a tail vein injection of the chemotherapeutic drug cisplatin (100 mg/m2) on the first day of imaging. Data was acquired immediately prior to cisplatin injection and 24 hours and 48 hours after.

A custom built 36 kHz swept source OCT system (similar to system 100) was used for in-vivo acquisition of data. For each imaging time point, two-dimensional frames of OCT data were acquired at 200 frames per second over approximately 8 seconds. Each frame contained 180 axial scans and covered a lateral distance of 3 mm. Data sets were acquired from imaging planes within the window chamber of each mouse. Method 200 was applied to each pixel location of an ROI within tumors at 0 hours, 24 hours and 48 hours to obtain an average decorrelation time at each of 0 hours, 24 hours and 48 hours.

FIG. 11 shows these average decorrelation times computed from the tumor ROI's treated with cisplatin at 0 hours, 24 hours and 48 hours. It is appreciated from FIG. 11 that there is an increase in average decorrelation time within the ROI as tumor cells lose viability and undergo cell death as confirmed by histological data (for example as in “Measuring intracellular motion using dynamic light scattering with optical coherence tomography in a mouse tumor model”, Proc. SPIE 8230, 823002 (2012) to the inventors, and incorporated herein by reference). Indeed, this result is in contrast to FIG. 9 where decorrelation rates decreased over a similar given time period of 48 hours in in-vitro samples.

In summary, concepts from dynamic light scattering have been adapted and applied to OCT techniques to obtain measures of intracellular motion over time and successful experiments have demonstrated that this method can reliably detect changes in the rate of intracellular motion between viable and apoptotic cells in-vivo and in-vitro. Hence, dynamic light scattering can now be applied to OCT; specifically it can be determined that cell death has occurred in a biological sample when respective indications of respective signal decorrelation rates changes over a given time period, wherein the respective signal decorrelation rates can one of increase or decrease over the given time period.

Those skilled in the art will appreciate that in some embodiments, the functionality of systems 100, 100′ can be implemented using pre-programmed hardware or firmware elements (e.g., application specific integrated circuits (ASICs), electrically erasable programmable read-only memories (EEPROMs), etc.), or other related components. In other embodiments, the functionality of systems 100, 100′ can be achieved using a computing apparatus that has access to a code memory (not shown) which stores computer-readable program code for operation of the computing apparatus. The computer-readable program code could be stored on a computer readable storage medium which is fixed, tangible and readable directly by these components, (e.g., removable diskette, CD-ROM, ROM, fixed disk, USB drive). Furthermore, it is appreciated that the computer-readable program can be stored as a computer program product comprising a computer usable medium. Further, a persistent storage device can comprise the computer readable program code. It is yet further appreciated that the computer-readable program code and/or computer usable medium can comprise a non-transitory computer-readable program code and/or non-transitory computer usable medium. Alternatively, the computer-readable program code could be stored remotely but transmittable to these components via a modem or other interface device connected to a network (including, without limitation, the Internet) over a transmission medium. The transmission medium can be either a non-mobile medium (e.g., optical and/or digital and/or analog communications lines) or a mobile medium (e.g., microwave, infrared, free-space optical or other transmission schemes) or a combination thereof.

Persons skilled in the art will appreciate that there are yet more alternative implementations and modifications possible for implementing the embodiments, and that the above implementations and examples are only illustrations of one or more embodiments. The scope, therefore, is only to be limited by the claims appended hereto.

What is claimed is:

1. A computing device for detecting cell death in a biological sample, the computing device comprising:
a processor, a memory and a communication interface, said processor enabled to:
receive a plurality of optical coherence tomography (OCT) data sets, each representative of OCT backscatter data collected from the biological sample and comprising respective intensity fluctuation as a function of time at different respective times over a given time period;
determine respective indications of respective signal decorrelation rates for each of said plurality of OCT data sets at each of said different respective times; and
determine that cell death has occurred in the biological sample when said respective indications of respective signal decorrelation rates changes over said given time period.

2. The computing device of claim 1, wherein said processor is further enabled to normalize each of said plurality of OCT data sets prior to said respective indications of respective signal decorrelation rates being determined.

3. The computing device of claim 2, wherein to normalize each of said plurality of OCT data sets, said processor is further enabled to subtract a respective signal mean from a respective original signal and divide by a respective standard deviation for each of said plurality of OCT data sets.

4. The computing device of claim 1, wherein said processor is further enabled to determine said respective indications of respective signal decorrelation rates by at least one of an autocorrelation analysis, power spectral density analysis, and wavelet analysis.

5. The computing device of claim 1, wherein said processor is further enabled to determine said respective indications of respective signal decorrelation rates by applying an auto-correlation function to said respective intensity fluctuation at each different respective time.

6. The computing device of claim 1, wherein said respective indications of respective signal decorrelation rates comprises at least one of:
a respective decay rate;
a respective decorrelation time;
a respective wavelet power spectrum amplitude;
a respective decay metric;
a respective half-width-half-max of respective auto-correlation curves; and
a respective exponential decay metric of said respective auto-correlation curves.

7. The computing device of claim 1, wherein said processor is further enabled to apply said function at a common region of interest (ROI) in each of said plurality of OCT data sets.

8. The computing device of claim 1, wherein the biological sample comprises an in-vitro biological sample.

9. The computing device of claim 1, wherein the biological sample comprises an in-vivo biological sample, and wherein said processor is further enabled to apply at least one in-vivo correction to each of said plurality of OCT data sets prior to said respective indications of respective signal decorrelation rates being determined to remove effects of in-vivo phenomenon from each of said plurality of OCT data sets.

10. The computing device of claim 1, wherein said plurality of OCT data sets is received via said communication interface.

11. The computing device of claim 1, wherein said plurality of OCT are stored in said memory.

12. The computing device of claim 1, wherein said processor is further enabled to at least one of:
store a cell death result in said memory when said processor determines whether said cell death has occurred;
output said cell death result to an output device; and
transmit said cell death result to a remote computing device via said communication interface.

13. The computing device of claim 1, further comprising OCT apparatus for obtaining said plurality of OCT data sets.

14. A method for detecting cell death in a biological sample using a computing device comprising a processor, the method comprising:
receiving a plurality of optical coherence tomography (OCT) data sets, each representative of OCT backscatter data collected from the biological sample and comprising respective intensity fluctuation as a function of time at different respective times over a given time period;
determining respective indications of respective signal decorrelation rates for each of said plurality of OCT data sets at each of said different respective times; and
determining that cell death has occurred in the biological sample when said respective indications of respective signal decorrelation rates changes over said given time period.

15. The method of claim 14, further comprising normalizing, at the processor, each of said plurality of OCT data sets prior to said determining said respective indications of respective signal decorrelation rates.

16. The method of claim 15, wherein said normalizing comprises subtracting a respective signal mean from a respective original signal and dividing by a respective standard deviation for each of said plurality of OCT data sets.

17. The method of claim 14, wherein said determining said respective indications of respective signal decorrelation rates occurs by at least one of an autocorrelation analysis, power spectral density analysis, and wavelet analysis.

18. The method of claim 14, wherein said determining said respective indications of respective signal decorrelation rates occurs by applying an auto-correlation function to said respective intensity fluctuation at each different respective time.

19. The method of claim 14, wherein said respective indications of respective decay rates comprises one of:
a respective decay rate;
a respective decorrelation time;
a respective wavelet power spectrum amplitude;
a respective decay metric;
a respective half-width-half-max of respective auto-correlation curves; and
a respective exponential decay metric of said respective auto-correlation curves.

20. The method of claim 14, wherein said function is applied to a common region of interest (ROI) in each of said plurality of OCT data set.

21. The method of claim 14, wherein the biological sample comprises an in-vitro biological sample.

22. The method of claim 14, wherein the biological sample comprises an in-vivo biological sample, and further comprising applying at least one in-vivo correction to each of said plurality of OCT data sets prior to said determining said respective indications of respective signal decorrelation rates to remove effects of in-vivo phenomenon from each of said plurality of OCT data sets.

23. A computer program product, comprising a computer usable medium having a computer readable program code adapted to be executed to implement a method for detecting cell death in a biological sample using a computing device comprising a processor, the method comprising:
receiving a plurality of optical coherence tomography (OCT) data sets, each representative of OCT backscatter data collected from the biological sample and comprising respective intensity fluctuation as a function of time at different respective times over a given time period;
determining respective indications of respective signal decorrelation rates for each of said plurality of OCT data sets at each of said different respective times; and
determining that cell death has occurred in the biological sample when said respective indications of respective signal decorrelation rates changes over said given time period.

24. A computing device for detecting cell death in a biological sample, the computing device comprising:
a processor, a memory and a communication interface, said processor enabled to:
receive a plurality of optical coherence tomography (OCT) data sets, each representative of OCT backscatter data collected from the biological sample and comprising respective signal fluctuation as a function of time at different respective times over a given time period;
determine respective indications of respective signal decorrelation rates for each of said plurality of OCT data sets at each of said different respective times; and
determine that cell death has occurred in the biological sample when said respective indications of respective signal decorrelation rates changes over said given time period.

25. The computing device of claim 24, wherein said processor is further enabled to normalize each of said plurality of OCT data sets prior to said respective indications of respective signal decorrelation rates being determined.

26. The computing device of claim 25, wherein to normalize each of said plurality of OCT data sets, said processor is further enabled to subtract a respective signal mean from a respective original signal and divide by a respective standard deviation for each of said plurality of OCT data sets.

27. The computing device of claim 24, wherein said processor is further enabled to determine said respective indications of respective signal decorrelation rates by at least one of an autocorrelation analysis, power spectral density analysis, and wavelet analysis.

28. The computing device of claim 24, wherein said processor is further enabled to determine said respective indications of respective signal decorrelation rates by applying an auto-correlation function to said respective signal fluctuation at each different respective time.

29. The computing device of claim 24, wherein said respective indications of respective signal decorrelation rates comprises at least one of:
a respective decay rate;
a respective decorrelation time;
a respective wavelet power spectrum amplitude;
a respective decay metric;
a respective half-width-half-max of respective auto-correlation curves; and
a respective exponential decay metric of said respective auto-correlation curves.

30. The computing device of claim 24, wherein said processor is further enabled to apply said function at a common region of interest (ROI) in each of said plurality of OCT data sets.

31. The computing device of claim 24, wherein the biological sample comprises an in-vitro biological sample.

32. The computing device of claim 24, wherein the biological sample comprises an in-vivo biological sample, and wherein said processor is further enabled to apply at least one in-vivo correction to each of said plurality of OCT data sets prior to said respective indications of respective signal decorrelation rates being determined to remove effects of in-vivo phenomenon from each of said plurality of OCT data sets.

33. The computing device of claim 24, wherein said plurality of OCT data sets is received via said communication interface.

34. The computing device of claim 24, wherein said plurality of OCT are stored in said memory.

35. The computing device of claim 24, wherein said processor is further enabled to at least one of:
store a cell death result in said memory when said processor determines whether said cell death has occurred;
output said cell death result to an output device; and
transmit said cell death result to a remote computing device via said communication interface.

36. The computing device of claim 24, further comprising OCT apparatus for obtaining said plurality of OCT data sets.

37. A method for detecting cell death in a biological sample using a computing device comprising a processor, the method comprising:
receiving a plurality of optical coherence tomography (OCT) data sets, each representative of OCT backscatter data collected from the biological sample and comprising respective signal fluctuation as a function of time at different respective times over a given time period;
determining respective indications of respective signal decorrelation rates for each of said plurality of OCT data sets at each of said different respective times; and
determining that cell death has occurred in the biological sample when said respective indications of respective signal decorrelation rates changes over said given time period.

38. The method of claim 37, further comprising normalizing, at the processor, each of said plurality of OCT data sets prior to said determining said respective indications of respective signal decorrelation rates.

39. The method of claim 38, wherein said normalizing comprises subtracting a respective signal mean from a respective original signal and dividing by a respective standard deviation for each of said plurality of OCT data sets.

40. The method of claim 37, wherein said determining said respective indications of respective signal decorrelation rates occurs by at least one of an autocorrelation analysis, power spectral density analysis, and wavelet analysis.

41. The method of claim 37, wherein said determining said respective indications of respective signal decorrelation rates occurs by applying an auto-correlation function to said respective signal fluctuation at each different respective time.

42. The method of claim 37, wherein said respective indications of respective decay rates comprises one of:
a respective decay rate;
a respective decorrelation time;
a respective wavelet power spectrum amplitude;
a respective decay metric;
a respective half-width-half-max of respective auto-correlation curves; and
a respective exponential decay metric of said respective auto-correlation curves.

43. The method of claim 37, wherein said function is applied to a common region of interest (ROI) in each of said plurality of OCT data set.

44. The method of claim 37, wherein the biological sample comprises an in-vitro biological sample.

45. The method of claim 37, wherein the biological sample comprises an in-vivo biological sample, and further comprising applying at least one in-vivo correction to each of said plurality of OCT data sets prior to said determining said respective indications of respective signal decorrelation rates to remove effects of in-vivo phenomenon from each of said plurality of OCT data sets.

46. A computer program product, comprising a computer usable medium having a computer readable program code adapted to be executed to implement a method for detecting cell death in a biological sample using a computing device comprising a processor, the method comprising:
receiving a plurality of optical coherence tomography (OCT) data sets, each representative of OCT backscatter data collected from the biological sample and comprising respective signal fluctuation as a function of time at different respective times over a given time period;
determining respective indications of respective signal decorrelation rates for each of said plurality of OCT data sets at each of said different respective times; and
determining that cell death has occurred in the biological sample when said respective indications of respective signal decorrelation rates changes over said given time period.
